(19) United States
(12) Patent Application Publication
(10) Pub. No.: US 2021/0031355 A1
(43) Pub. Date: Feb. 4, 2021

(54) Grip for a Handheld Instrument

(71) Applicant: Janet Mary Jackson-Coty, Haddonfield, NJ (US)

(72) Inventor: Janet Mary Jackson-Coty, Haddonfield, NJ (US)

(21) Appl. No.: 16/529,668

(22) Filed: Aug. 1, 2019

(51) Int. Cl. B25G 1/10

(52) U.S. Cl. CPC B25G 1/102; A46B 5/02

(57) ABSTRACT

A system, method, and apparatus may be provided for gripping a handheld instrument. A spherical body may be configured to support at least a portion of the handheld instrument. A working portion of the handheld instrument may be oriented below a body of the gripping device. A top opening may be provided at a top of the gripping device, wherein the top opening may be configured to receive a portion of the handheld instrument. A bottom opening at the bottom of the gripping device may be provided, wherein the bottom opening may be configured to receive a portion of the handheld instrument. A convex surface may receive a palmar surface of a user's fingers, thumb, and/or hand.

### CROSS-REFERENCE TO RELATED PATENT APPLICATIONS

This application claims the benefit of U.S. Provisional Application No. 62/715,773, filed on Aug. 7, 2018, which is incorporated by reference in its entirety.

### BACKGROUND

Neutral alignment of the joints of the fingers, thumb and hand is represented by the following ranges of joint positions: Forty five degrees of flexion at the metacarpal phalangeal joints, 30-45 degrees of flexion at the proximal inter phalangeal joints, 10-20 degrees of flexion at the distal inter phalangeal joints of the fingers, and partial abduction and opposition of the of the first carpal metacarpal joint, 10 degrees of flexion at the metacarpal phalangeal joint and 5 degrees of flexion at the inter phalangeal joint of the thumb. The intrinsic muscles are the smaller muscles located within the hand itself. The extrinsic muscle groups are the long flexors and extensors that move the fingers, thumb and hand. They are called extrinsic because their muscle bellies are located on the forearm.

This neutral alignment creates the optimal position for the balanced activation of the intrinsic muscles of the hand and extrinsic flexor muscles of the forearm that are recruited or activated when gripping and using a handheld instruments. This neutral positioning result in decreased stress and strain on the intrinsic muscles of the hand resulting in less fatigue and cramping of these muscles when using handheld instruments. Placing the center of mass of the handheld instrument close to the point of movement of the hand at the wrist joint also decreases the stress and fatigue on the intrinsic muscles of the hand and the extrinsic muscles of the forearm.

Several types of gripping devices for handheld instruments have been disclosed. These include modified handles that are integral to the handheld instrument and devices that attach to the handheld instrument or the handle of the handheld instrument. None of these devices, when used on the handheld instrument, positions the joints of the fingers of the hand in optimal alignment to decrease stress and strain to the intrinsic muscles of the hand and decrease the potential for fatigue and cramping of these muscles when using the handheld instrument. None of these devices, when being used on the handheld instrument, positions the center of mass of the handheld instrument close to the point of movement of the hand at the wrist joint which decreased the amount of torque created by the hand held instrument at point of movement of the hand around the user's wrist. Decreasing the torque created by the handheld instrument decreases the amount of work required of the intrinsic muscles of the hand and the extrinsic muscles of the forearm resulting in decreased fatigue of these muscles when gripping and using the handheld instrument.

### BRIEF SUMMARY

The general purpose of the present invention that will be subsequently described in greater detail is to improve the manner in which a handheld instrument is gripped. Specifically, it is a device that, when used on the handheld instrument, positions the joints of the fingers of the hand in optimal alignment to decrease stress and strain to the intrinsic muscles of the hand and decrease the potential for fatigue and cramping of these muscles when using the handheld instrument. To attain this, the present invention comprises a substantially spherical body having a hole that is offset from the center of the spherical body toward the front of the body for receiving the handle of the handheld instrument and an exterior for receiving the users' thumb, fingers and palmar surface of the hand.

An objective of the present invention is to provide a grip that, when used on a handheld tool, positions the users' hands in neutral alignment to decrease the amount of work required by the muscles of the hand and forearm when using the handheld instrument.

Another objective of the present invention is to provide a grip that, when used on a hand held tool, places the hand held tool close to the axis of movement of the user's hand at the user's wrist joint to decrease the amount of torque produced by the hand held instrument, therefore, decreasing the amount of work that the users' muscles need to produce to use the hand held instrument.

Another objective of the present invention is to decrease the amount of stress and strain on the muscles of the hand and forearm when using a handheld instrument by positioning the user's hand in neutral alignment and placing the hand held instrument close to the axis of movement of the user's hand at the user's wrist.

The present invention is used for aiding in the gripping of a handheld instrument that is comprised of a somewhat long cylindrical handle and a flat portion that is an extension of or attached to the cylindrical handle. The present invention includes a substantially spherical body having a hole for receiving the handle of the handheld instrument. The present invention includes exterior gripping surfaces for receiving the palmar surface of the user's thumb, a second gripping surface for receiving the palmar surface of the fingers of the user's hand and a third surface for receiving the palm of the user's hand.

A system, method, and apparatus may be provided for gripping a handheld instrument. A spherical body may be configured to support at least a portion of the handheld instrument. A working portion of the handheld instrument may be oriented below a body of the gripping device. A top opening may be provided at a top of the gripping device, wherein the top opening may be configured to receive a portion of the handheld instrument. A bottom opening at the bottom of the gripping device may be provided, wherein the bottom opening may be configured to receive a portion of the handheld instrument. A convex surface may receive a palmar surface of a user's fingers, thumb, and/or hand.

A system, method and apparatus may be provided for gripping a hand held instrument that may be comprised of a material that will compress or deform to conform to the user's hand and to the hand held instrument.

A system, method and apparatus may be provided for gripping a hand held instrument that may have a surface that is textured and/or non-skid on the exterior concave surface or within the hole, grove, opening that receives the hand held instrument.

### BRIEF DESCRIPTION OF THE DRAWINGS

This invention may be embodied in the form illustrated in the accompanying drawings. The drawings, however, are illustrative only and changes may be made in the specific construction illustrated and described within the scope of the claims.

FIG. 1 shows the front view of the device 100.

FIG. 2 shows the side view of the device 100,

FIG. 3 shows the bottom of the device 100.

FIG. 4 shows the front view of the device 100 mounted onto a handheld instrument 400 in the form of a paintbrush.

FIG. 5 shows the side view of the device 100 mounted onto a handheld instrument 400 in the form of a paintbrush.

FIG. 6 shows the bottom of the device 100 mounted onto a handheld instrument 400 in the form of a paintbrush.

FIG. 7 shows the side view of a cross section of the device 100 mounted onto a handheld instrument 400 in the form of a paintbrush.

### DESCRIPTION

The invention relates to a grip for a handheld instrument for aiding persons in holding or gripping a handheld instrument.

The handheld instrument grip is positioned on a handheld instrument for use and provides a gripping surface for the user's hand which positions the fingers, the thumb and the hand in neutral alignment. This alignment allows for activation of both the intrinsic muscles of the hand and the extrinsic muscles of the forearm to reduce discomfort and cramping of the smaller intrinsic muscles of the hand while using the handheld instrument. This device, when being used with a handheld instrument, positions the center of mass of the handheld instrument close to the point of movement of the hand at the wrist joint. This decreases the amount of torque around the point of movement of the hand at the wrist resulting in a decrease in the amount of work that needs to be produced by the intrinsic and extrinsic muscles of the hand and wrist resulting in decreased stress and fatigue to the intrinsic muscles of the hand and the extrinsic muscles of the forearm.

This device is used for aiding in the gripping of a handheld instrument that is comprised of a somewhat long handle (e.g., cylindrical handle) and/or a portion (e.g., flat portion) that may be an extension of, or attached to, the cylindrical handle. The device may include a substantially spherical body having a hole that is offset from the center of the spherical body toward the front of the body for receiving the handle of the handheld instrument and an exterior for receiving the user's thumb, fingers, and/or palmar surface of the hand. The offset hole may run through the entire body of the device (e.g., from top to bottom). The hole may widen to the sides of the device at the bottom of the device, for example, to transform to a groove (e.g., a rectangular, square, oval, etc., groove). The groove may be wider on one side than another side. For example, the groove may be wider from side to side than from front to back. The groove may be offset from the center of the spherical body toward the front of the device in alignment with the hole.

The hole at the top of the device may receive the handle of the handheld instrument. The groove (e.g., rectangular groove) at the bottom of the device may receive a portion (e.g., the flat portion) of the handheld instrument. The handle (e.g., cylindrical handle) of the handheld instrument may be inserted into the device, for example, from the bottom through the rectangular groove and through the device to exit at the hole at the top of the device. The handle of the handheld instrument may extend beyond the upper surface of the device as it passes through the hole at the top of the device. The flat portion of the handheld instrument may fit (e.g., snuggly fit) into the groove at the bottom of the device. The flat portion of the handheld instrument may extend beyond the groove (e.g., rectangular groove) at the bottom of the device, for example, so that the working portion of the handheld instrument may extend below the device.

The position of the device when placed on the handheld instrument may be at the relative center of the handheld device, for example, where the user's thumb, fingers, and/or hand may be positioned if the user was using the handheld instrument without the gripping device. In other examples the position of the device when placed on the handheld instrument may be on one or more sides of the handheld device.

The substantially spherical body of the device may fill the space created by the user's thumb, fingers, and/or hand when positioned in neutral alignment with one or more of the following example alignments: thirty to fifty (e.g., forty five) degrees of flexion at the metacarpal phalangeal joints, fifteen to sixty (e.g., thirty to forty-five) degrees of flexion at the proximal inter phalangeal joints, five to thirty (e.g., ten to twenty) degrees of flexion at the distal inter phalangeal joints of the fingers, and partial abduction and opposition of the of the first carpal metacarpal joint, five to fifteen (e.g., ten) degrees of flexion at the metacarpal phalangeal joint, and/or five degrees of flexion at the inter phalangeal joint of the thumb.

The exterior may include a first gripping surface for receiving the palmar surface of the user's thumb, a second gripping surface for receiving the palmar surface of the fingers of the user's hand, and/or a third surface for receiving the palm of the user's hand. The first gripping surface may be on the front of the device and/or may have one or more concave depressions for receiving the palmar surface of the users thumb and/or may include surface indicia for providing a reference for the placement of the thumb of the user's hand. The surface indicia may include one letter or word to designate the placement of a right or left thumb. The character may be disposed at a level different than the level of the surfaces adjacent to the character.

The exterior surface may include a second gripping surface that may be on the back of the device, for example, for receiving the palmar surface of the user's one or more (e.g., four) fingers. The exterior surface may include a third gripping surface on the side of the device, for example, between surfaces one and two, that may be used for receiving the palm of the user's hand. A side may receive the palm of a right-handed user and another side may receive the palm of a left-handed user. The spherical shape of the exterior surfaces of the device may place the joints of the user's hands in the position of neutral alignment.

The exterior surface of the device (e.g., where the user's hand is in contact with the device) and/or the interior surface of the device (e.g., where the hand held instrument comes in contact with the device) may have a textured and/or a nod skid surface.

The device may be made of a material that compresses or conforms (e.g. closed cell foam, plastic silicon) to allow the device to conform to the shape of the hand held instrument and/or conform to the user's hand and to allow the hand held device to fit (e.g., snuggly fit) into the device.

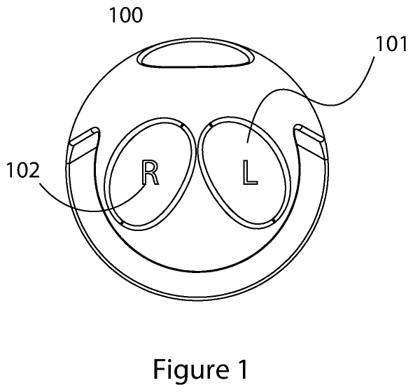

FIG. 1 shows a front view of an example device, as described herein. The view includes the concave surfaces 101 which may receive the pad of the right or left thumb depending on the hand that the user prefers for gripping and using the handheld instrument. The concave surfaces may include surface indicia 102 for providing a reference for the placement of the thumb of the user's hand. Example surface indicia may include a letter such as “R” or “L,” or a word such as “right” or “left” to designate the placement of a tight or left thumb. The character may be disposed at a level different than the level of the surfaces adjacent to the character.

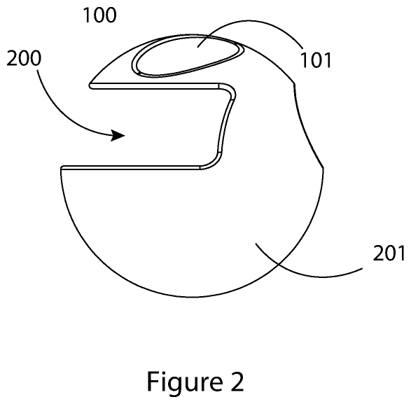

FIG. 2 shows the side view of an example device, as described herein. The view includes the groove (e.g., rectangular groove, oval groove, etc.) 200 that may receive the flat surface of the handheld instrument and the curved surface 201 that may receive the four fingers of the user's hand. As described herein, the groove and/or curved surface may place the user's hand (e.g., fingers of the user's hand) in neutral finger alignment. FIG. 2 includes the curved surface 101 that receives the thumb of the user's hand and places the thumb in neutral thumb alignment.

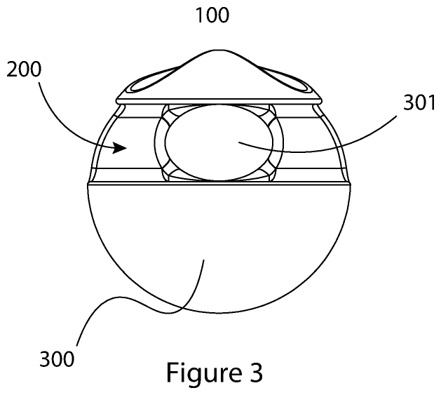

FIG. 3 shows the bottom of an example device, as described herein. The view includes the spherical body 300 of the device, rectangular groove 200 (that may be offset from the center of the spherical body of the device) for receiving the flat surface of the handheld instrument, and the bore hole 301. The bore hole 301 may be used to offset from the center of the spherical body of the device, for example, for receiving the handle of the handheld instrument.

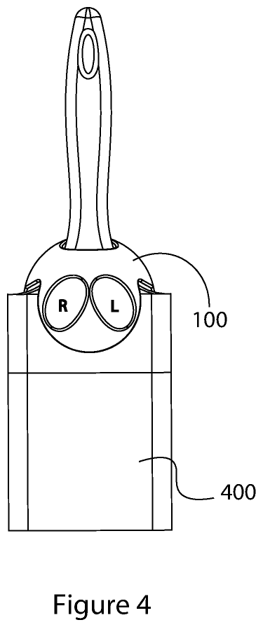

FIG. 4 shows the front view of the example device mounted onto a handheld instrument 400. Although the handheld instrument is shown as a paintbrush in FIG. 400, it is understood that the handheld instrument may be any instrument that may be held by one or more hands. For example, the handheld instrument may be a hand tool, a sporting instrument, a writing tool, etc. The view includes an example orientation of the handheld instrument when the ergonomic gripping device 100 is attached.

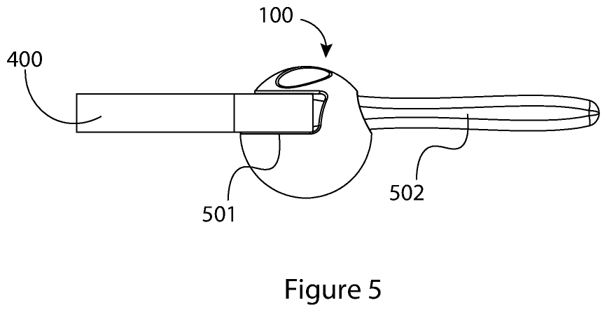

FIG. 5 shows the side view of the device mounted onto a handheld instrument 400 in the form of a paintbrush, although the paintbrush is for illustration purposes only. FIG. 5 includes the flat surface 501 and the handle of the handheld instrument 502 as they are positioned in the device 100.

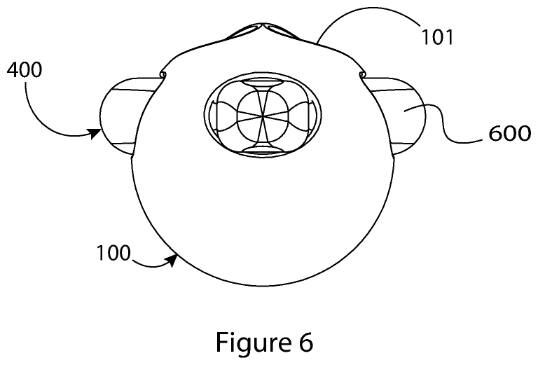

FIG. 6 shows the bottom of the device mounted onto a handheld instrument 400 in the form of a paintbrush, although the paintbrush is for illustration purposes only. The view includes the flat surfaces 600 of the handheld instrument as it is positioned in the rectangular grove 400 of the device. This view also includes the view of the curved surfaces 101 that receive the user's thumb and fingers.

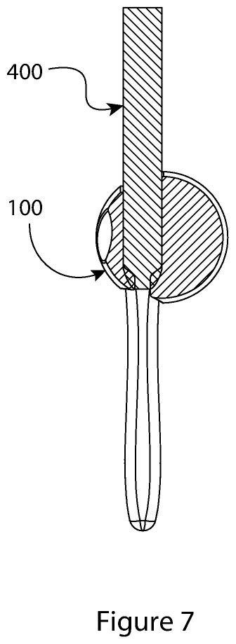

FIG. 7 shows the side view of a cross section of the device mounted onto a handheld instrument 400 in the form of a paintbrush.

What is claimed is:

1. A method for gripping a handheld instrument, comprising:
receiving the handheld instrument in a first opening located at a first side of the gripping device;
passing at least a portion of the handheld instrument through a second opening positioned at a second side of the gripping device;
supporting the handheld instrument via a spherical body of the gripping device, wherein a working portion of the handheld instrument is oriented below the spherical body of the gripping device; and
receiving, via a convex surface of the spherical body of the gripping device, a palmar surface of a user's fingers, thumb, and hand.

2. The method of claim 1, wherein the first opening traverses a top of the gripping device to a bottom of the gripping device.

3. The method of claim 2, wherein the first opening is offset from a center of the gripping device toward a front side of the gripping device.

4. The method of claim 2, wherein the first opening receives a handle of the handheld instrument.

5. The method of claim 4, wherein the handle extends beyond the upper surface of the gripping device as it passes through the first opening of the gripping device.

6. The method of claim 2, wherein the first opening widens at the bottom of the device to transform to the second opening, the second opening being a rectangular groove.

7. The method of claim 6, wherein the rectangular groove is larger from side to side of the than from front to back.

8. The method of claim 6, wherein the rectangular groove is offset from the center of the spherical body toward the front of the gripping device in alignment with the first opening at the top of the gripping device.

9. The method of claim 6, wherein the rectangular groove receives a flat portion of the handheld instrument.

10. The method of claim 9, wherein the flat portion of the handheld instrument extends beyond the rectangular groove of the apparatus so that the working portion of the handheld instrument extends below the gripping device.

11. The method of claim 1, wherein an exterior surface of the griping device includes gripping surfaces for receiving the palmar surface of the user's hand.

12. The method of claim 1, wherein a front of the gripping device has at least one concave depression for receiving the palmar surface of the user's thumb.

13. The method of claim 12, wherein the at least one concave depression for receiving the palmar surface of the user's thumb includes surface indicia for providing a reference for the placement of the thumb of the user's hand.

14. The method of claim 13, wherein the surface indicia comprises a letter or word to designate the placement of a right thumb or a left thumb.

15. The method of claim 1, wherein the exterior surface comprises a second convex gripping surface for receiving the palmar surface of the fingers of the user's hand.

16. The method of claim 11, wherein the exterior comprises a third convex surface for receiving a palm of the user's hand.

17. The method of claim 1, wherein a convex surface on a third side of the gripping device receives a palm of a right-handed user and another cony surface on a fourth side receives a palm of a left-handed user.

18. The method of claim 1, wherein the device is comprised of a conforming material.

19. The method of claim 1, wherein the device comprises a textured and non-skid surface.

20. A gripping device, comprising:
a first opening located at a first side of the gripping device configured to receive a handheld instrument;
a second opening positioned at a second side of the gripping device configured to pass at least a portion of the handheld instrument through;
a spherical body of the gripping device configured to support the handheld instrument, wherein a working portion of the handheld instrument is oriented below the spherical body of the gripping device; and
a convex surface of the spherical body of the gripping device configured to receive a palmar surface of a user's fingers, thumb, and hand.
